(19) United States
(12) Patent Application Publication
(10) Pub. No.: US 2010/0235432 A1
(43) Pub. Date: Sep. 16, 2010

(54) Distributed Server Network for Providing Triple and Play Services to End Users

(75) Inventor: Elmar Trojer, Taby (SE)

Correspondence Address: ERICSSON INC., 6300 LEGACY DRIVE, M/S EVR 1-C-11, PLANO, TX, 75024, US

(73) Assignee: Telefonaktiebolaget L M Ericsson, Stockholm (SE)

(21) Appl. No.: 12/438,450

(22) PCT Filed: Aug. 21, 2006
(86) PCT No.: PCT/SE06/00956

§ 371 Date: Feb. 23, 2009

(51) Int. Cl. G06F 15/16; H04N 7/173; G06F 17/30

(52) U.S. Cl. 709/203; 725/109; 707/827; 707/E17.01

(57) ABSTRACT

A distributed server framework for distributing streamed electronic content to users. The framework includes a central server connected to regional edge servers, which are connected to local groups of access servers closest to the users. A file sharing protocol maintains hit lists indicating the relative popularity of various content. To reduce the traffic load from the central server and regional servers, popular material is stored on the access servers; less popular material is stored on the edge servers; and seldom requested material is stored on the central server. A sliding window and cursor mechanism enable smart distribution of hot material and breaking news among the access servers.

### TECHNICAL FIELD OF THE INVENTION

The present invention relates generally to a distributed server framework for distribution of content to users, a method for providing content to users, and access as well as edge servers for use in the distributed server network. In particular the invention relates to IP based distribution of streamed TV and video.

The distributed server framework is designed to be used as an overlay network to an access, aggregation, and transport network for triple play services.

### BACKGROUND

Alcatel strategic white paper [Ref. 1] describes a triple play service delivery architecture based on two major network elements, a broadband service aggregator (BSA) and a broadband service router (BSR). Television (TV) and video on demand (VoD) are delivered to the subscribers using multicast routing. The Alcatel paper says: Multicast routing improves the efficiency of the network by reducing the bandwidth and fibre needed to deliver broadcast channels to the subscriber. A multicasting node can receive a single copy of a broadcast channel and replicate it to any downstream nodes that require it, thus substantially reducing the required network resources. This efficiency becomes increasingly important closer to the subscriber. Multicast routing should therefore be performed at each or either of the access, aggregation and video edge nodes.

In the Alcatel paper a plurality of subscribers are connected to a BSA via an access node referred to as a VDSL (very high speed digital subscriber line) node. Several access nodes are connected to a BSA. Several BSAs are connected to a BSR, and the BSR is connected to an IP based transport network. A BSA is a Ethernet-centric aggregation device that aggregates traffic for all services towards the BSR and incorporates Internet Group Management Protocol (IGMP) proxy multicasting. A BSR is an edge device for Dynamic Host Configuration Protocol (DHCP) based video service delivery. It assigns IP addresses to the hosts dynamically and includes multicast routing.

FIG. 1 illustrates a traditional network comprising a broadband remote access server (BRAS) 1 at the edge of an aggregation network 2 and an external network 3. Other locations for the BRAS are also possible, exemplary it may sit in the external network. Application servers 4, also referred to as Web servers, are connected to the BRAS and contain material to be distributed to individual users 5. A user requests the particular data material he/she wants to watch and in response the BRAS forwards the requested data material all the way down, from the application server, through the transport network, over the aggregation network and via the access domain to the user's customer premise equipment (CPE). An individual CPE is illustrated with a small rectangle. CPEs are connected to the aggregation network via a DSL access network 7 and access nodes 8. A number of CPEs are connected to an access node. A group of access nodes are via first links 9 connected to an Ethernet switch 10 with access node-controller functionality. Two Ethernet links are shown, each connected to a respective group of access nodes. The Ethernet switches are connected to the BRAS via respective second links 11. A BRAS typically serves several non-shown aggregation networks. In the local loop digital subscriber lines (DSL) 12 are used between a CPE and the access node. In the illustrated example the external network is also referred to as a transport network and is typically an IP network, and each access node is an IP based digital subscriber line access multiplexer (IPDSLAM) connected to 10 different CPEs. IPDSLAMs serving 8, 12 or other numbers of CPEs are also conceivable. An IPDSLAM is transporting the stream that has the requested data material and places it on the correct DSL. An IPDSLAM is an interface between ATM or Ethernet based transmission technology used in the local loop and IP over Ethernet transmission technology used in the aggregation network. Typically the IPDSLAMs are located in a central office or in a remote outdoor cabinet.

Double headed arrow 13 in the lower part of FIG. 1 illustrates the geographical extension of the so called first mile in the aggregation network that is the first mile from a CPE to an access node. The double headed arrow 14 illustrates the geographical extension of the so called second mile of the aggregation network that is the distance between an access node and the BRAS.

The following should be observed: The first links extend between an Ethernet switch and an access node along the second mile. The first links are not to be confused with the DSL lines which extend along the first mile between an access node and the users. In the following specification the terms of third links and fourth links will also appear. With the used terminology there is no mental connection between first links and first mile, second links and second mile as one might imagine.

Single headed arrow 15 points at the access nodes which define the so called first aggregation level at which each individual DSL, having a maximum bandwidth of about 24 Mbps in ADSL2+ transmission mode [Ref. 2] are aggregated onto one first link that has a bandwidth of 10 times 24 Mbps that is 240 Mbps. At the second aggregation level, illustrated by single headed arrow 16 pointing on the BRAS, traffic on 24 second links, each with a bandwidth of 240 Mbps, are aggregated onto a single link that has a bandwidth of 5.76 Gbps [Ref. 3].

The DSL standard is the most deployed first mile broadband access technology over the last ten years due to the perfect fit of the technology into the Internet world and low deployment costs involved by the technology.

In DSL the free spectrum on the twisted pair copper wire, traditionally used to provide the Plain Old Telephone Service (POTS) or Integrated Services Digital Network (ISDN) services, is used to transport digitally modulated data.

The concept of asymmetric DSL (ADSL), allows a user to send data requests to servers somewhere in the Internet in the upstream direction and to download the requested data with ten to twenty times the upstream speed from the Internet in downstream direction. With ADSL2+, theoretically up to 24 Mbps in downstream and 1 Mbps in upstream are possible. Since the rate is dependent on the loop length, in practice 10 Mbps are supported on most DSLs. With VDSL2 as a successor of ADSL2+ asymmetrical rates around 80/20 Mbps and symmetrical rates around 50/50 Mbps are supported on short loops of a length around 1 km [Ref. 4].

Traditionally, ADSL is widely used to provide best-effort broadband Internet access to the users. The service access is fully controlled by the BRAS and all data from and to the application servers must pass the BRAS to constrain the user service access by service policies.

Recently, European telecom operators started to upgrade their DSL networks to provide triple play services i.e. to provide video, voice and classical Internet services on a single DSL to hold or even increase Average Revenue per User (ARPU). Video services (Broadcast IPTV, Video on Demand) are thereby the most powerful new-comers in terms of possibilities and revenues. Unfortunately, video related services are the ones that place the highest Quality of Service (QoS) constrains on the DSL network and drive existing network technologies to the border of feasibility.

The more user-specific video content requested by the users gets, the more traffic has to flow from the BRAS through the aggregation network part down the access network towards the user. In such situations multicast protocols cannot longer be used, since each user demands its individual unicast traffic flow that adds up bandwidth in the network. It turns out, that the traditional access scheme as shown in FIG. 1 is not sufficient to provide fully user-tailored video content to each user due to the fact that overload situations occur in parts of the transport, aggregation and access network.

IPTV multicast in a network structure like the one depicted in FIG. 1, works according to the principle shown in FIG. 2. A video service provider offers different video channels CH1 and CH2 that are fed into the network by a video head-end situated behind the BRAS. Via the

Internet Group Management Protocol (IGMP) users subscribe to a channel by sending an IGMP group join message to the IPDSLAM. If at least one user connected to an IPDSLAM joins a channel, the IPTV traffic is streamed to that IPDLSAM. In the topmost group, labeled A, users 1 and 4 have requested channel CH1, in the middle group, labeled B, users 1, 3 and 4 have requested CH1 and users 6, 8 and 10 have requested to watch CH2. In the bottommost group, labeled C, CH2 has been requested by users 6 and 8. CH1 provided by a first video service provider (television company) is delivered to the BRAS. CH2, perhaps delivered from another service provider (television company), is also delivered to the BRAS. From the BRAS a single copy of CH1 and a single copy of CH2 is streamed to the Ethernet switch over the second link. At the Ethernet switch CH1 is copied and streamed to the IPDSLAMs of groups A and B over some of the first links. At the IPSLAM of group A CH1 is copied and delivered to users 1 and 4 and at the IPDSLAM of group B CH1 is copied and distributed to users 1, 3 and 4. At the Ethernet switch CH 2 is copied and streamed to the IPDSLAMs of groups B and C over some other first links. At the IPDSLAM of group B CH2 is copied and distributed to users 6, 8 and 10. At the IPDSLAM of group C CH2 is copied and steamed to users 6 and 8. Since no user in group A has requested CH2, the Ethernet switch does not stream CH2 to the IPDSLAM of group A. Likewise CH1 is not streamed to the IPDSLAM of group C, since no user in the group requested it.

In this multicast situation, if a channel is already subscribed by a user, an additional user joining the channel does not increase the bandwidth-demand in the aggregation or transport network. If for example user 7 in group B wants to watch CH1 or CH2, the IPDSLAM of group B will receive a corresponding request from user 7 and will in response make another copy of CH1 or CH2 and stream it to user 7.

In the above example the bandwidth requirement on the second link is twice that of a channel CH. Generally seen the bandwidth requirement on second link will be proportional to the number of channels it transports. Likewise the bandwidth requirement on a single first link is proportional to the number of channels the link transports. An additional user, wanting to watch a channel that is already streamed will not increase the bandwidth demand on the second link. If the additional user belongs to a group to which the channel is already streamed the bandwidth demand on the first link will not increase. If the additional user belongs to a group to which the desired channel is not already streamed, the bandwidth demand on the (first) link to the group he/she belongs will increase with the amount required by a channel CH.

It is clear that in the multicast situation above, the flexibility in content for the users is quite limited. The user can just choose from a set of live TV channels and has no means to profile the streamed content. In particular true video on demand is not supported. True video on demand (VoD) means a user can start to watch a movie at any time he/she pleases. In the multicast situation a user has to wait until a movie becomes alive. A movie becomes alive when it is multicasted, which typically happens at some predetermined times of the day or when a sufficient numbers of users have requested the same movie. True VoD also means that a user can control time-shifts in the movie, such as to start, stop and pause the movie during playback of the movie, to play the movie forward or backward or to play it fast forward or fast backward. Time-shifts are not possible with multicasting. True VoD also means a user can add special information, such as sub-titles or different language sound lines, to a video.

The more user-specific video content requested by the users gets, the more traffic has to flow from the BRAS through the aggregation network and over the access network towards the user. In such situations multicast protocols cannot longer be used, since each user demands its individual unicast traffic flow that adds up bandwidth in the network.

Multicasting in an existing network will also give rise to quality of service (QoS) problems because of mismatch on each aggregation level. On the first aggregation level a couple of DSL lines 12, each in practice providing a bandwidth in the order of about 10 Mbps, are aggregated on a first link 9 that can provide around 100-200 Mbps. Exemplary there are 10 DSLs each having a rate of 15 Mbps that are aggregated on one first link that has a rate of 100 Mbps. In order to fully use the full bandwidth resources available the ten DSLs (that is 150 Mbps) the first link would need to be overloaded and take 150 Mbps. A similar problem exists on the second aggregation level where several first links 9 are aggregated on one second link 11 that provides a bandwidth in the order of about 1-5 Gbps. In order to be able to fully use the bandwidth available at the several first links the second link need to be overloaded. Since the ingress bandwidth is different from the outgress bandwidth, there is a mismatch and the quality degrades. This happens on each aggregation level. Accordingly, a quantity problem regarding bandwidth arises at each aggregation level which turns into a quality problem regarding transmission. These problems are related. If bandwidth is not enough on a weak link onto which many links are aggregated, then one cannot get the right transmission quality because the weak link need to overload. If one wants to maintain a certain transmission quality and not overload the weak link, then the available bandwidth resources of the many aggregated links are not fully used.

Another problem with existing multicast technique relates to channel switching. Suppose a user wants to switch from a first program to a second program and that the second program is not available at the IPDSLAM serving the user. In that case, and following the IGMP protocol, the corresponding channel switching order will propagate from the IPDSLAM via the Ethernet switch, to the BRAS that controls the multicasting. The BRAS will take the necessary steps, signal to the user's IPDSLAM. The IPDSLAM will react to the signaling and finally the channel is switched. The time elapsed between the channel switching order and the time instant the second channel is viewed by the user is considerable, in the order of several 100 milliseconds, and the user perceives the multicast system as slow and sluggish.

A possible solution to the problem of providing flexible content to each user would be to distribute the content by using unicast routing. Unicast of programs means that the BRAS provides individualized, that is personalized, streams to each of the users. In such a case the bandwidth demands on the first and second links is proportional to the number of users connected to that link. Since a channel typically has a bandwidth requirement in the order of about 5 Mbps this means that 100 000 users would require the second and first links to have a bit rate in the order 500 Gbps. Today this is not possible to realize with reasonable economical investments in the second mile lines.

FIG. 3 is a diagram illustrating the bandwidth requirement versus number of users in three different cases, curves 17, 18 and 19 respectively. A channel is supposed to have a bandwidth requirement of 5 Mbps. Curve 17 represents the worst case of multicasting. The steep sloping part of curve 17 illustrates how the bandwidth demand increases as the number of channels increases. Along this part of the curve it is assumed, in the worst case, that each additional viewer requests a new channel. Say for example that when 40 different users have requested 40 different channels, a bandwidth of 200 Mbps on curve 17 is attained. Then, new additional users join the groups; these new additional users wanting to watch any of the 40 channels. The bandwidth demand will not increase, as is represented by the horizontal part of curve 17, irrespective of the number of added new users.

Curve 18 is similar to curve 17 and relates to multicast of 40 different channels in an experienced case. The steep sloping part of curve 18 illustrates how the bandwidth demand increases as the number of channels increases. Along this part of the curve it is assumed, like in the worst case, that each one of 10 different viewers requests a new movie. Thereafter, as represented by the less sloping part of curve 18, additional users join the groups, some of the additional users requesting an already live movie, some of them requesting a new movie, until a total of 40 different channels have been requested over time.

Curve 19 represents the bandwidth required if personalized programs are transmitted to users by using unicast technique. Each user will in this case be provided with its own stream of data each such stream being individualized by the BRAS. Thus true VoD is provided. In this case the bandwidth demand is proportional to the number of users. An individual stream of data material has a bandwidth demand in the order of about 5 Mbps and user. It is obvious that if unicast is used to deliver individualized streams to hundreds of thousands of users heavy overload problems in the IP network and in the second mile network will arise.

It turns out, that the traditional access scheme as shown in FIG. 2 is not sufficient to provide fully user-tailored video content to each user due to the fact that overload situations occur in parts of the transport, aggregation and access network.

### SUMMARY

It is the object of the invention to avoid the disadvantages mentioned above and to provide an improved distributed server framework as well as servers in accordance with the independent claims.

The below listed and numbered advantages are achieved with the invention. In the detailed description they will be referred to using their respective numbers. This will avoid repetitious language.

[ADV1] An advantage achieved with the invention is that popular data material are stored in access servers close to the users thereby reducing the number of links over which the data material needs to be streamed. The gap between the provider of the data material and the users is reduced; the popular data material needs only to be streamed over the first mile. In such a way, the network is prevented from overloading (network congestion) and all links can be optimally utilized.

[ADV2] By using the file sharing technique for distribution of fragments of the data material among the servers of the distributed server framework the storage capacity available in each of the distributed servers is combined with one another. One fragment of the data material is stored on one server, another fragment is stored on another. Since every single server of the distributed server framework is used for storage, it is even possible to reduce the total storage requirement. The file sharing protocol also distributes the fragments of the data material to be stored equally among the servers, thereby providing for storage balancing

[ADV3] By having different fragments of the data material stored on different servers, it is possible to fetch the different fragments from the different servers and put them together in an ordered sequence and stream a full copy of the data material to a user. A server does not need to store a full copy of the data material, it is sufficient to store fragments of the data material. A user will have all of the data material stored on the different servers that is the combined storage capacity of the servers, to his/her disposal.

[ADV4] Data material that is injected into the central server will be chopped into an ordered sequence fragments and each fragment will be documented and provided with a message authentication code. Every single fragment of data material injected into the server framework is documented and is subject to authentication. It is therefore not possible for a hostile user to upload unwanted data material.

[ADV5] Data material need only be injected once into a central server in the distributed server framework. No copies need to be injected, thereby reducing the storage capacity of the distributed server framework.

[ADV6] The file sharing protocol supported by the tracker takes care that fragments are always exchanged in an optimal way in terms of bandwidth. That is why all links in the framework are utilized optimally and load balancing is achieved.

[ADV7] Further, the combined storage capacity is used for smart storing of the data material by avoiding storage of duplicate copies of the data material. This will also spare bandwidth in the first mile of the access network.

[ADV8] The distributed server framework in accordance with the invention is easy to scale. If the number of users grow, it will be sufficient to add a corresponding number of access servers and edge servers to the existing server framework.

[ADV9] The distributed server framework in accordance with the invention provides true VoD and personalized user streams.

[ADV10] Switching between channels in IPTV is quick and takes place with low latency.

[ADV11] The distributed server framework in accordance with the invention allows for private video recording (PVR) of a channel while simultaneously watching a channel.

[ADV12] The distributed server framework can in principle be used for the distribution and exchange of all kind of data formats, such as video, music and data.

[ADV13] The distributed server framework in accordance with the invention can be used with any type of access medium, such as traditional twisted copper wire and air (radio).

### BRIEF DESCRIPTION OF THE DRAWINGS

FIG. 1 illustrates a traditional network for providing triple play services to users,

FIG. 2 illustrates multicast routing of IPTV in the network shown in FIG. 1,

FIG. 3 is a diagram illustrating the bandwidth requirement versus number of users using multicast routing and unicast routing respectively,

FIG. 4 illustrates the server topology of the distributed server framework in accordance with the invention,

FIG. 5 illustrates a distributed server framework in accordance with the invention implemented on an existing network for providing triple play services to users,

FIG. 6 illustrates a part of the distributed server framework in accordance with the invention and should be related to FIG. 7,

FIG. 7 is a flow chart illustrating how content is diffused in the distributed server framework in accordance with the invention when the servers use a file sharing program,

FIG. 8 is a diagram illustrating the sliding window mechanism,

FIG. 9 is a part of the distributed server framework in accordance with the invention and illustrates user requests made at different time instants,

FIG. 10 is a timing diagram illustrating sliding window principle as applied to the users shown in FIG. 9,

FIG. 11 is a block diagram of a central server (CS) in accordance with the invention,

FIG. 12 is a block diagram of an edge server (ES) in accordance with the present invention, and

FIG. 13 is a block diagram of an access server (AS) in accordance with the invention.

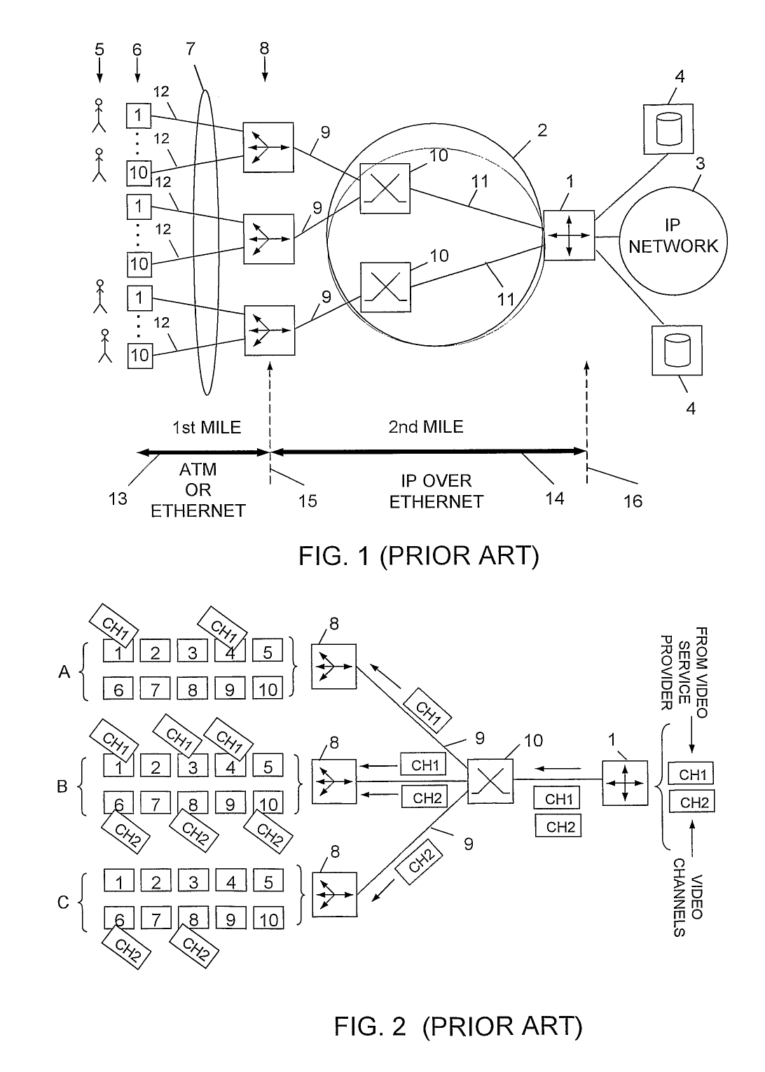

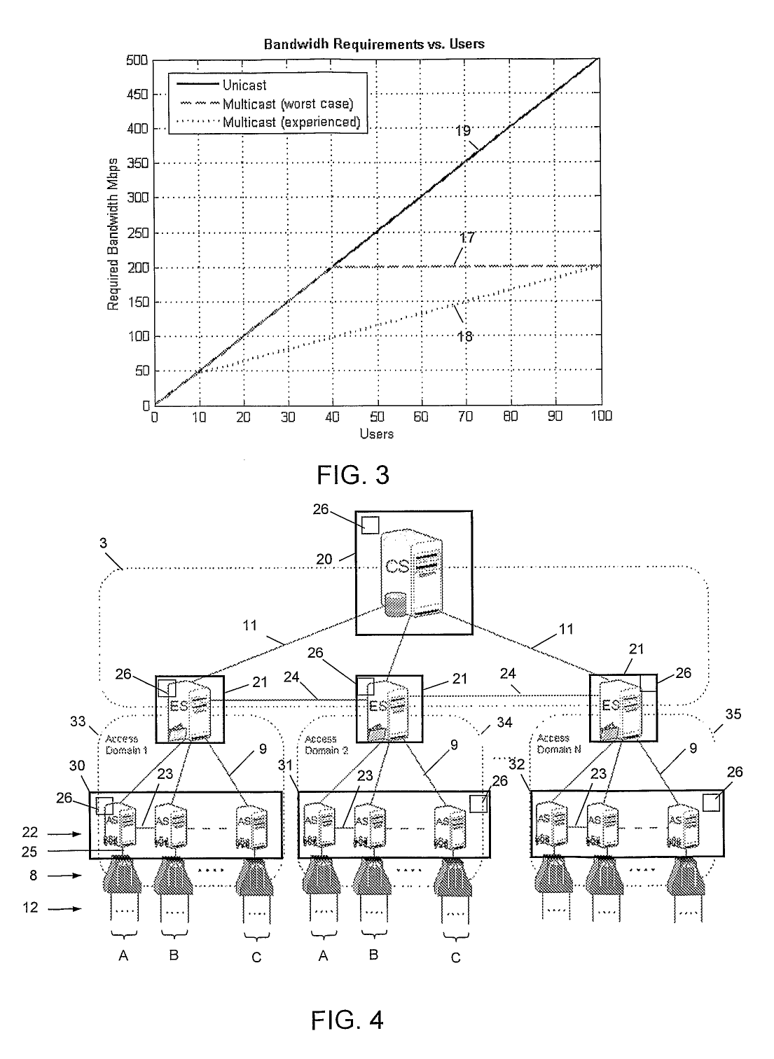

### DETAILED DESCRIPTION OF THE INVENTION

FIG. 4 illustrates the topology of the distributed server framework in accordance with the invention. It comprises a central server (CS) 20, a number of edge servers (ES) 21, a plurality of access servers (AS) 22, the first links 9, the second links 11, third links 23, fourth links 24, fifth links 25, and file sharing client/server protocol 26. The third and fourth links are not necessarily dedicated physical links. The access servers form AS groups 30, 31 and 32. Each AS is connected to an IPDSLAM 8 over a fifth link 25. Groups A, B, C, . . . of users are connected to an associated IPDSLAM over their respective DSL lines 12.

Each AS group 30-32 belongs to a respective access domain 33, 34 and 35. An access domain is typically a part of a metro network, exemplary the north, south, west or east part of a capital such as Stockholm or Berlin. In each AS group, each AS is connected to a respective ES over respective first links. There is one ES in each access domain. An ES sits at the edge between an access domain and the transport network 3. The CS is connected to the transport network and may for example sit at the point of presence (PoP) of a service provider.

The ASa in a domain are inter-connected by the third links 23, whereas ESs are connected between domains via the forth links 24.

Each AS, ES and CS has a file sharing client/server protocol 26, symbolically shown with a rectangle. For reasons of clarity the file sharing client/server protocol in the access servers has not been shown at each AS, since this would blur the picture, instead the file sharing client/server protocol is illustrated in each of the AS groups 30-32.

In a preferred embodiment the server framework comprising the ASs, the ESs and the CS form an overlay network to an already existing data network in which case the servers are interconnected using existing links of the data network. Preferably the first and second links 9 and 11 respectively are parts of the existing network and the access as well as edge servers are in this case connected to the data network in a manner known per se. Depending on the implementation, the ESs may be interconnected via the CS and the second links in which case the fourth links are not physical links. The ASa of a group may in a similar manner be interconnected via an ES over the first links 9 in which case the third links 23 are not physical links. Advantage [ADV8] mentioned above is achieved with the overlay concept.

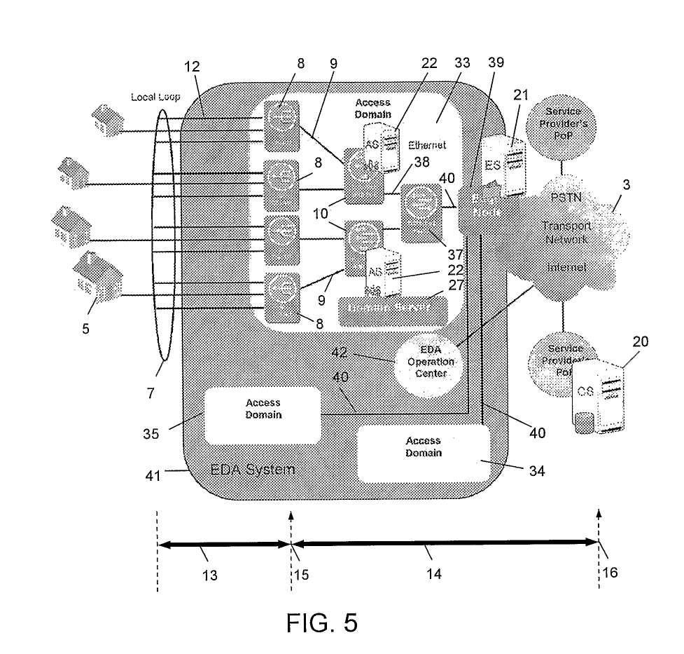

In the embodiment shown in FIG. 4 an AS is connected to one IPSSLAM. In an alternate embodiment an AS is connected to two IPDSLAMs as is shown in FIG. 5.

FIG. 5 illustrates an already existing network into which access servers, edge servers and a central server have been connected as an overlay network. The existing network is shown to comprise three access domains 33-35 each one having a structure like the one shown at 33 and each one comprising a plurality of IPDSLAMs 8, Ethernet switches 10 and a domain server 27. Users are connected to the IPDSLAMs over the DSLs 12 in the local loop 7. The IPDSLAMs are connected to the two Ethernet switches 10 by the first links 9. The two Ethernet switches are connected to a common Ethernet switch 37 by links 38. The common Ethernet switch 37 is connected to an edge node 39 by a link 40. Each access domain is thus connected to the edge node by a respective link 40.

An example of an existing access domain is the EDA system provided by Ericsson. The EDA system is an ADSL/VDLS2 based flexible access system which is available to customers of such a system, [Ref. 3].

The three access domains together form a regional domain 41. The edge node sits at the edge between the regional domain and the transport network 3. The regional domain further comprises an operation center 42 from which the access network is operated.

Typically there are several regional domains, each one having an edge node 39 sitting between the regional domain and the transport network. The many regional domains together form a nation wide access network.

In each access domain shown in FIG. 5 access servers AS are connected to the Ethernet switches 10, a edge server ES is connected to the edge node 39 and a central server CS is connected to the transport network 3, thereby forming a distributed server framework in accordance with the invention.

At the bottom part of FIG. 5 the extension of the first mile is illustrated by the double headed arrow 13 and the extension of the second mile by the double headed arrow 14.

The server framework works like a Peer to Peer (P2P) data sharing network. The protocols involved are a modified version of a file sharing protocol. Examples of file sharing protocols are Bittorrent, Gnutella and others.

The Bittorrent Protocol

A popular description of the Bittorrent protocol is available at [Ref. 5].

Bittorrent is file sharing protocol for effective downloading of popular files letting the down loaders help each other in a kind of P2P-networking. The effective downloading is attributable to the fact that the piece of the total data amount a user has been downloaded is further distributed to other users which haven't received this piece.

Bittorrent concentrates on the task of transferring files as fast as possible to as many users as possible by the users upload small pieces to each other. A group of users which are interested in the same file is called a swarm.

A common problem with popular files, for example trailers of movies coming-up soon, is that many people want to have the files immediately after their release. This will overload the user machines and the network connections and everybody must wait unnecessarily long until they can download. With Bittorrent download to everybody becomes quicker the larger the swarm becomes, advantages [ADV3, ADV6] mentioned above are thereby achieved. The Bittorrent protocol breaks the file(s) down into smaller fragments or pieces. Peers download missing fragments from each other and upload those that they already have to peers that request them.

Downloading is straightforward. Each person who wants to download the file, first downloads a torrent file, and then opens the Bittorrent client software. The torrent file tells the client the address of the tracker. The tracker maintains a log of which users are downloading the file and where the file and its fragments reside. The client requests the rarest block it does not yet have and imports it. Then it begins looking for someone to upload the block to. In this manner files are shared among the user machines.

A torrent means either a torrent file or all files described by it.

The torrent file contains metadata about all the files it makes downloadable, including their names, sizes and checksums. It also contains the address of a tracker.

A tracker is a server that keeps track of which seeds and peers are in the swarm. Clients report information to the tracker periodically. A peer asks a tracker where to find a missing piece.

A peer is one instance of a Bittorrent client running on a computer on the Internet that you connect to and transfer data. Usually a peer does not have the complete file, but only parts of it.

A seed is a peer that has a complete copy of the torrent. The more seeds there are, the better chances are for completion of the file. A seed is uploading material to other peers.

A leech is usually a peer who has a very poor share ratio, a leech downloads much more material than it uploads.

A superseeer is the seeder of material that is uploaded for the first time. A superseeder will usually upload fewer bits before downloaders begin to complete. It strictly limits the uploading of duplicate pieces.

With Bittorrent every user can inject new material into the network and start to seed it. Even illegal material may be injected.

If a superseeder is missing a fragment then no one else can download a 100% correct file.

The Modified File Sharing Protocol in Accordance with the Invention

In the preferred embodiment of the invention a modified version of the Bittorrent protocol is used. According to the modified Bittorrent protocol, user machines, typically PCs and set-top boxes, are not included in the file sharing, that is they don't have the protocol. Only the access servers, the edge servers and the central server participate. An access server acts as a Bittorrent-proxy.

The file protocol used in the distributed server framework according to the invention is inherited from the Bittorrent protocol. Further to the modifications mentioned above the Bittorrent protocol has been slightly modified to fit the streaming video requirements in an IPTV network, [ADV3]. Several differences can be identified between traditional Internet Bittorrent networks and the distributed video server framework that is under consideration here:
In traditional torrent networks, different fragments of a file are downloaded from different sources simultaneously and the download order of the pieces does not play a role if all pieces are available in the network (normally rare pieces are higher prioritized). In an IPTV network, movies are watched linear in time and thus movie fragments have to become available when they are needed and the order in which the fragments are presented to the user is important. Thus the prioritizing algorithm is given by the content. The provisioning of fragments that are to be watched have the highest priority. Fragments that are needed later decrease in priority. To implement the prioritizing algorithm the below described sliding window and cursor mechanism is used. The sliding window and cursor mechanism is a novel modification of a file sharing protocol, [ADV3].
In traditional torrent networks different clients have different upload/download bandwidths. These differences in bandwidth have to be taken into account to provide cooperative file sharing. Moreover security means have to be provided to forbid so called leeching and stubbing that is downloading without uploading as a service in return. In the distributed server framework according to the invention no such security means are needed because the environment is friendly and all servers are trusted. All client programs on an aggregation level are equal in bandwidth configuration and cooperation and trading is performed in a friendly and cooperative environment. The distributed server framework in accordance with the invention is a controlled network with no hostile users that try to cheat, [ADV4].

With the modified file sharing protocol in accordance with the invention there is only one node that is allowed to inject data material into the server framework and that is the central node, [ADV4].

With the modified file sharing protocol in accordance with the invention a peer does not have to download a complete file, as it have to do with the Bittorrent protocol, only a plurality of fragments of the file need to be downloaded. This is because the downloaded material is streamed to the users according to the cursor and sliding window mechanism described below, [ADV2, ADV6].

With the modified file sharing protocol in accordance with the invention the edge servers and the access servers are always seeding/uploading fragments if they have fragments that a user requests.

Another modification is the use of hit lists in the file sharing protocol. Loosely speaking a hit list is used to control the time during which an individual fragment of a file is stored in a database on the access server and in an edge server respectively. Each fragment on each server has its own hit list. Each time a fragment is requested the hit list of the fragment is stepped up by one, [ADV2, ADV6].

Popular material is stored on access servers. If no one has requested a fragment, stored on an AS, during a configurable first time period, the fragment is deleted from the AS. In this manner an AS will only store popular material. Thus, each time a fragment is requested the predefined time period can be prolonged. Exemplary the first time period is in the area of hours or days, [ADV1].

Less popular material is stored on the edge servers. If no one has requested a fragment, stored on an ES, during a configurable second time period, longer than the first time period, the fragment is deleted from the ES. In this manner an ES will store less requested material, i.e. less popular material. Each time a fragment is requested the predefined time period can be prolonged. Exemplary the predefined second time period is in the order of weeks, [ADV1].

Seldom requested and thus unpopular material is stored on the central server. There is no need for a hit list on fragments stored on the CS.

New video content, for example a movie, is injected into the CS and from there spread to ES and AS upon requests from users. Such requests are sent over the DSL to the CS in the uplink using the RTSP protocol, [Ref. 6]. The CS thereby chops the file comprising the movie into an ordered and addressable number of fragments, exemplary one megabyte per fragment. If downloads start, the CS acts as a super-seeder since no other server has fragments of the movie. In super-seeding mode the CS allows for multiple downloads towards different protocol clients. The involved ES and AS store the downloaded fragments and can start to trade with them. The CS keeps a list which indicates, for each fragment of each movie injected into the CS, at which servers in the server framework the fragment is presently stored. In this phase of diffusion, data pieces are exchanged mutually between ES and AS in a fair way, [ADV6]. A tracker in the CS keeps a list in a database that holds information about which fragments of a movie are stored where in the distributed server network (tracking list).

Thus if a user request new fragments, the tracker gives information on where to obtain these pieces in the most efficient way. An ES tracker knows the identities and addresses of all fragments stored on the access servers connected to it, [ADV2, ADV12].

The download/uploading bandwidth for each AS and ES is symmetrical, i.e. each server is playing a fair game when it comes to obtaining required fragments and providing fragments. Like in Bittorrent a tit for tat game is played between the file-sharing servers to gain global Pareto efficiency, [ADV2].

Each piece a server has obtained is stored in the database and kept there for a configurable expiration time period. New download requests (hits) on a fragment can prolong the expiration date since it indicates that the file is popular and well-used. Since each server has a limited amount of storage space, the hit-list defines the priorities of the pieces to keep in the memory (aging-out priorities). Since ES and AS have different bandwidth and storage constrains the amount of data and the kind of data held on the servers is different, [ADV1, ADV2].

With this strategy, the diffusion phase will lead to a state where either absolutely new material is super-seeded by the CS or very old and seldom demanded material is downloaded from the CS. ES then holds a little bit older material due to the fact that a larger amount of memory is available and expire dates are longer. The AS keeps just pieces of the most recent data material that is demanded often, [ADV1].

This behavior corresponds to the typical download statistics for video related material. If new content is available it becomes popular after some time-delay and demand rises tremendously. Later, the number of requests decreases exponentially together with the bandwidth demand.

The CS is the top-most server in the server hierarchy and the tracker used therein is called a super-tracker. The CS is also the server into which new material initially is injected. Material injected into the CS is stored on the CS. It is always available to the users and is in principle never deleted. Thus the CS stores the full file that can be downloaded by connected servers. Each server in the network that downloads the file and stores fragments of the file is added to a so called swarm of a file and the tracker can be asked where fragments of the file can be found (tracking functionality). Protocol clients on the servers mutually exchange file fragments until the whole file is loaded. A client that has the whole file serves as seeder as long as the file is not deleted from the memory.

The central server thereby acts as super-seeder with tracking functionality that contains all source content material to its full extent, [ADV12]. The edge server and access servers act like leechers/seeders storing only fragments. The user connected to the DSL acts as pure leecher and does not upload any data material. If new data is distributed in the network and there is a lot of demand then full content can be directly copied to the edge servers and they are then super-seeding, thereby reducing the full load on the CS in the beginning of the diffusion mode. Also edge servers can act as super-seeders to reduce the CS seeding load. If document fragments have been fully captured on an edge or access server, this server acts as seeder (are always uploading if they are holding some material needed by others) for a predefined time period until the content is deleted manually from the server or aged-out by means of a hit list. In such a way, different fragments of a file will be downloaded from the nearest possible server. The load on the second links to the central server will thereby be relieved. This structure circumvents the problems outlined in connection with the description of FIG. 2.

Since the access servers and the edge servers are arranged distributed in a network there are many first and second links that share the traffic load, the bandwidth on the first and second aggregation levels will therefore increase and thereby reduce the mismatch and increase the QoS of the distributed data material. Expressed in other words, there are more links a user can get data material from, [ADV1]

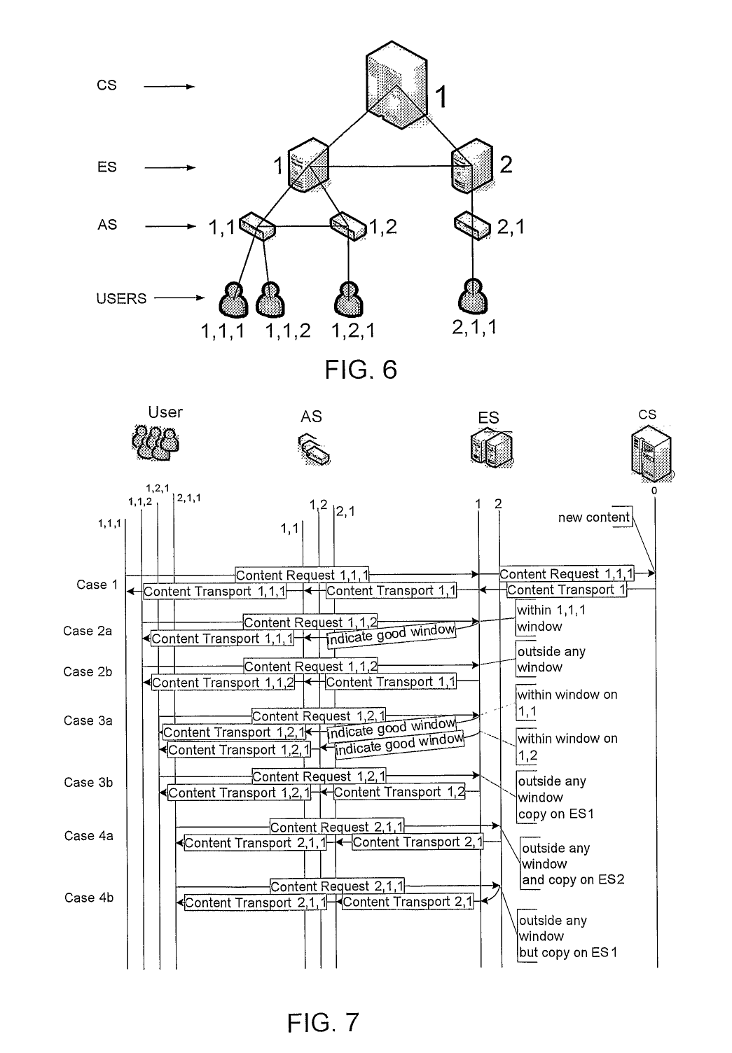

Refer to FIG. 6 which illustrates a setup used to illustrate various content distribution situations according to the modified file sharing protocol. Short reference signs are used in this figure in order to make it easy to compare FIG. 7 with FIG. 6. A single central server CS 1 is connected to two edge servers ES 1 and ES 2. On ES 1 two access servers AS 1,1 and AS 1,2 are connected, whereas on ES 2 just a single AS 2,1 is connected. Two users 1,1,1 and 1,1,2 are connected to AS 1,1. On AS 1,2 a single user 1,2,1 is connected. User 2,1,1 is connected to AS 2,1. Content can be either a fragment of a document or a whole document in that sense.

Now refer to FIG. 7 that illustrates seven different content distribution cases:

Case 1:
User 1,1,1 request content that is available at the CS only. The tracker in ES 1 is responsible for the request and forwards the request to the CS since it does not have any record in its tracker list. The tracker list in CS is empty for the requested content and the content is therefore streamed towards the user via AS 1,1 by the CS itself. ES 1 intercept the transmission and stores the content that is relayed to AS 1,1. CS and ES update their tracking lists.

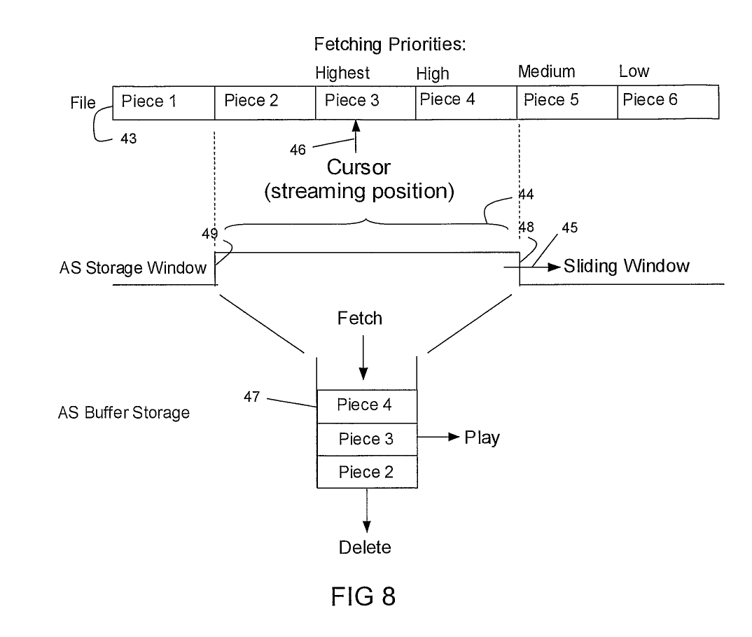

Case 2a:
User 1,1,2 requests the same content as user 1,1,1 and ES 1 indicates that AS 1,1 can offer a useful window (the one for user 1,1,1). So the AS 1,1 now streams the requested content directly to user 1,1,2. Regarding the sliding window and cursor mechanism, refer to FIGS. 8-10 and the corresponding text below.

Case 2b:
User 1,1,2 request the content but the window of user 1,1,1 cannot be used because the cursor is to far away. Since EC1 still has a copy (checked in the tracker list), it is streamed to the user and the hit list is updated.

Case 3a:
User 1,2,1 on AS 1,2 requests the same content. If ES 1 finds a fitting window on either of its AS 1,1 or 1,2 the content can be used directly from the server. In case both servers have a window, the closer server is used, i.e. AS 1,2. Tracker and hit list on ES 1 are updated.

Case 3b:
User 1,2,1 request the content via its ES 1 but no AS has a fitting window. If the content is stored on ES 1, it is taken from ES 1 and the hit list is updated. Otherwise the tracker list helps to find missing pieces.

Case 4a:
User 2,1,1 is requesting content which is already located on ES 2. The content is transported directly to AS 2,1.

Case 4b:
User 2,1,1 requests content that is not found on ES2 directly. The tracker list in ES 2 indicates that there is a copy of the requested content on ES 1 from which the content is transported to ES 2 and stored. The tracker list on ES 2 is updated and the content is added to the hit list.

FIG. 8 illustrates the sliding window and cursor mechanism. The CS has divided a content file into an ordered sequence of fragments and assigned each fragment a serial number. The file sharing protocol has diffused the fragments over the server framework so that they are stored on different servers. A movie is watched linearly which means the fragments presented to the viewer must appear in correct order. A streaming protocol, exemplary the real time streaming protocol (RTSP), must stream the fragments in the ordered sequence to the user. To achieve this, the sliding window and cursor mechanism is used. At the users AS there is a buffer for the fragments and this buffer should be loaded with the fragments. In FIG. 8 the file to be reconstructed and streamed to the user from the AS is shown at 43. Its fragments have been marked Piece 1, Piece 2 etc. Firstly the mechanism, embodied in the form of program software, comprises a sliding window 44 that can be thought of as moving linearly with time as illustrated by arrow 45. A cursor 46 is associated with the sliding window. The cursor is a part of the above mentioned prioritization algorithm and points at the piece that is being streamed to the user, i.e. the piece the user is currently watching. A buffer 47 is storing the pieces that are within the sliding window 44. In this case the cursor points at Piece 3. When the cursor points at Piece 3 the mechanism asks CS where to find Piece 4 which is the next piece to be streamed. CS responds by giving the address to the server on which the piece is stored and the mechanism fetches Piece 4 at the indicated server. Finally Piece 4 is stored in the buffer. Next, the sliding window moves to the right, the cursor points at Piece 4, the piece with the priority marked “high”. Piece 4 is now streamed to the user and Piece 3 becomes history. The mechanism now asks CS where to find Piece 5. CS responds, Piece 5 is fetched and stored in the buffer. The sliding window 44 moves again together with the cursor 46. All pieces within the sliding window 44 are kept within the buffer, [ADV1, ADV10]. The size of the buffer should be large enough to store pieces that are about to be streamed to a user within the immediate future. Exemplary, if it takes about 5 seconds to stream a piece to a user, then the buffer should be able to store pieces that are about to be streamed during the next following 5 minutes in order to provide a fluent and non-interrupted play out of the content at the user. In such a case the sliding window and the size of the buffer shall accommodate 60 pieces and not just three as shown in FIG. 8. The sliding window mechanism and the buffer are located in the AS and are embodied in the form of software, hardware or a combination thereof. The size of the sliding window and the size of the buffer are configurable.

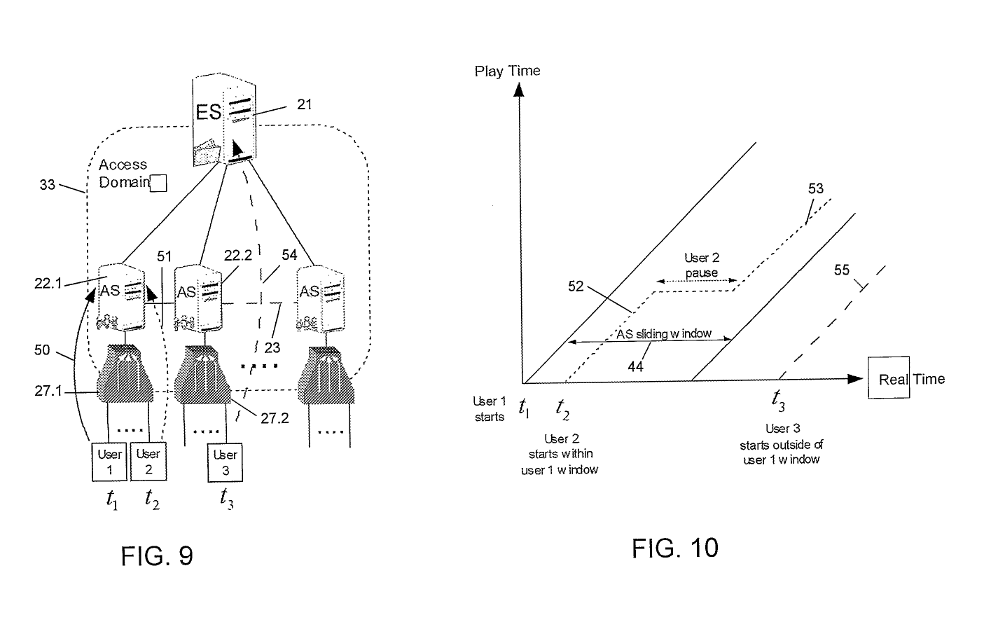

Suppose a first user is watching the movie that is represented by file 43 in FIG. 8. If a second user on the same AS as the first user wants to watch the same movie the sliding window mechanism makes a copy, in the AS, of the movie, provided the second user is within the sliding window of the first user. The copy is then streamed to the second user. This will relief the load on the first mile network, particular if the movie or IPTV program is very popular and demanded by many. Moreover time shifting is made quite easy. In order to explain this, refer to FIGS. 9 and 10, [ADV9, ADV10].

FIG. 9 illustrates the set up at access domain 33 with user 1 and user 2 connected to AS 22.1 via IPDSLAM 27.1 and user 3 to AS 22.2 via IPDSLAM 27.2. The access servers AS 22.1 and AS 22,2 are connected to ES 21. FIG. 10 is a timing diagram associated with FIG. 9. Real time is along the x-axis and play time (the time during which the movie is played out) is along the y-axis. The sliding window size, and thus also the size of the streaming buffer, is represented by arrow 44 and pertains to user 1. All ASa in the server framework are using Internet Group Management Protocol (IGMP) snooping which means an AS is peeking into requests sent by other users connected to the same AS, [ADV7, ADV8].

Since an ES tracker knows the identities and addresses of all fragments stored on the access servers connected to it, the ES knows where to find a proper sliding window to fetch fragments around the cursor, [ADV10].

User 1 sends a request, represented by arrow 50, for a particular movie and starts to watch the movie at time t₁. AS 22.1 fetches the fragments of the movie at AS 22.1 and streams the movie to user 1. For user 1 the play time is the same as the real time. At time t₂ user 2 sends a request, represented by arrow 51, for the same movie and starts to watch the same movie. Since t₂ is within the sliding window 44 the fragments of the movie streamed to user 1 are copied in AS 22.1 and are streamed to user 2. This is part 52 of the dashed line 53 associated with user 2. If user 2 pauses his movie for a time corresponding to the horizontal part of user's 2 dashed line 53, in which case the play time stops and the real time remain increases, and resumes the play out at a time instant within the sliding window the movie fragments of user 1 are still available in the streaming buffer 47 and will be streamed to user 2. Thus user 2 fetches the movie from AS 22.2.

If another user on AS 22.1 is watching another movie than user 1, user 1 will have instant access to this movie, provided the channel switching request is done within the sliding window associated with said other movie.

Still referring to FIG. 10, at time t₃ user 3 requests the same movie as user 1, this request being represented by arrow 54. Since time t₃ is outside the sliding window of user 1, user 3 has to fetch the movie from the edge server 21. User's 3 movie time—real time line is shown at dashed line 55.

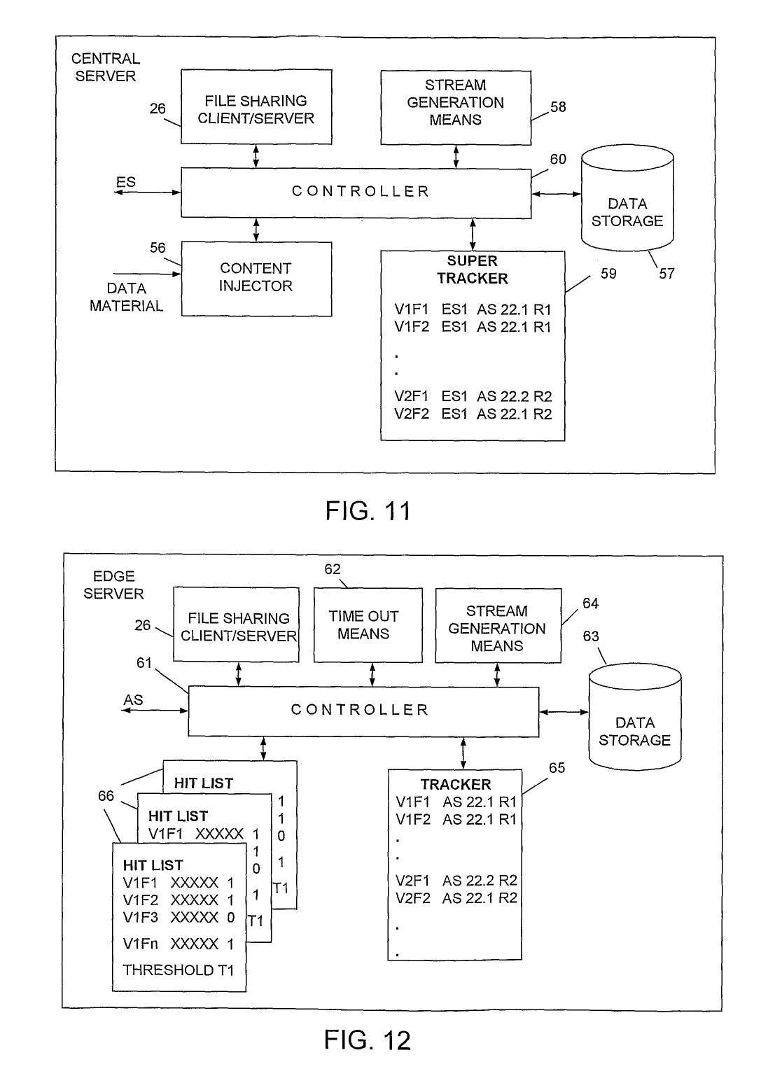

FIG. 11 is a block diagram of the central server. It comprises a content injector 56, a data storage 57, the file sharing client/server protocol 26, stream generation means 58, a super tracker 59 and a controller 60 controlling the inter-action between the listed units. The super tracker keeps a list of all files available in the data storage, together with client specific location data and disassembly information. In particular the list holds the address of all clients that have fragments of a file, the fragment numbers and the actual upload and download rates of a client. Clients (ES and AS) ask the super tracker where to download missing fragments. The client requesting fragments learns from the super tracker on the basis of the streaming rates from where to stream data upwardly or downwardly in the server hierarchy. With this concept the super tracker helps to find the ‘best’ peer to download from. The best peer would be the peer with lowest loading. This means that if another client requests an identified piece of an identified content, the super tracker knows where the piece can be found and can advise the client where to take it from. The super tracker will not advise to take the piece from a server that is overloaded or has a high load, instead it will advise to take the requested piece from another server that is not so much loaded. The super tracker has knowledge of all the rates used, and therefore also the load, on the links used in the server framework, [ADV1, ADV6, ADV7].

Exemplary the list entry V1F1 refers to video movie no. 1 fragment no 1 thereof, V2F1 to video movie 2 fragment 1 etc. At this entry V1F1 the addresses of the clients that contain a copy of entry are listed, in the illustrated case ES1 and AS 22.1. Download rates are indicated by R1, R2, . . . in the list. The content injector is a part of a non-shown management interface of a management system located in the operation center 42 shown in FIG. 5. From the management system it is possible to manually delete non-wanted data material stored in the central server, [ADV1].

FIG. 12 is a block diagram of an edge server that comprises a controller 61, time out means 62, a data storage 57, the file sharing client/server protocol 26, stream generation means 59, a tracker 65 and hit lists 66. The controller is controlling the inter-action between its connected units. An ES stores all fragments it has received. All fragments stored at the ES together with information on how often and when these fragments have been requested by other peers are stored on the hit lists. A hit list is used to give the priorities by which fragments be kept stored. A hit list also tells which fragments are to be deleted from storage that is those fragments that are rarely used and have timed out (aged out).

In particular in the hit list referring to movie no. 1, the entry V1F1, that refers to fragment no 1 of the movie, the column XXXX contains the number of hits on the fragment. For each fragment there is a running count of the hits on the fragment. The count is stepped up by one each time there is a hit. In the hit list there is a column containing 0s and 1s. A one (1) in the column indicates that the associated fragment is available, a zero (0) indicates the associated fragment is not longer required and can be deleted from the data store.

A fragment is stored on an edge server as long as its number of hits exceeds a certain threshold T1. The threshold is configurable. Exemplary T1 is configured to 10 000 hits. If the running count exceeds T1 during a configurable time period, say for example five days, the fragment is marked with a one (1) as is indicated at V1F1 and V1F2. If the running count of a fragment is less than T1 for the configurable time period, then the fragment has timed out and can be erased. A non-available fragment is marked with a zero (0) as is shown at V1F3.

Many other implementations of the function of the hit list are possible. Exemplary a hit increases a zero set counter by one and after a predefined time, exemplary one minute, the count is reduced by one. In this case no thresholds are needed, because it is sufficient to see if the counter is above or below zero. Hits are pulling the counter up, time is pulling the counter down.

If the data storage 63 is full and new pieces are needed to be stored, the hit lists again give information of what to keep and what to erase. All available pieces are shared. Full files are seeded.

In the block diagram there is one hit list per stored data file. It is also possible to use one common hit list.

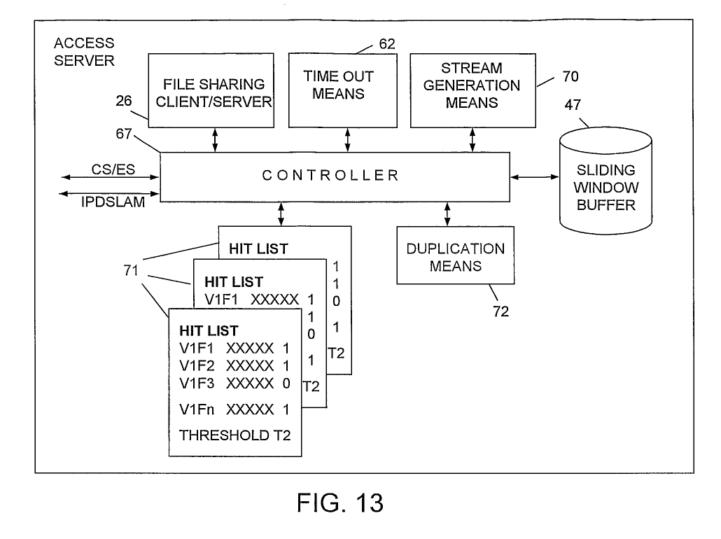

FIG. 13 is a block diagram of an access server that comprises a controller 67, time out means 62, sliding widow buffer 47, file sharing client/server protocol 26, stream generation means 59, hit lists 71 and duplication means 72. The controller is controlling the inter-action between its connected units. An AS stores all fragments it has received. All fragments stored at the AS together with information on how often and when these fragments have been requested by other peers are stored on the hit lists. A hit list is used to give the priorities by which fragments are stored. The hit list also tells which fragments are to be deleted from storage, that is those fragments that are rarely used and have aged out.

In particular in the hit list referring to movie no. 1, the entry V1F1, that refers to fragment no 1 of the movie, the column marked XXXX contains the number of hits on the fragment. For each fragment there is a running count of the hits on the fragment. The count is stepped up by one each time there is a hit. In the hit list there is a column containing 0s and 1s. A one (1) in the column indicates that the associated fragment is available, a zero (0) indicates the associated fragment is not available and can be deleted from the data store.

A fragment is stored on an access server as long as its number of hits exceeds a certain threshold T2. The threshold is configurable. Exemplary T2 is configured to 100 000 hits. If the running count exceeds T2 during a configurable time period, say for example two days, the fragment is marked with a one (1) as is indicated at V1F1 and V1F2. If the running count of a fragment is less than T1 for the configurable time period, then the fragment has timed out and can be erased. A non-available fragment is marked with a zero (0) as is shown at V1F3.

If the data storage 63 is full and new pieces are needed to be stored, the hit lists again give information of what to keep and what to erase. All available pieces are shared.

In the block diagram there is one hit list per stored data file. It is also possible to use one common hit list.

Access servers are placed in the first aggregation point 15 and therefore have very limited storage and processing capabilities. A limited number of users are using an AS.

The sliding window buffer holds file fragments according to the sliding window principle, see FIG. 8. Thus an AS rather holds fragments around the cursor 46 than full files. The window 44, see FIG. 8, defines how much of the history should be stored in the sliding window buffer 47.

Thus all popular material, such as popular movies and breaking news, will be stored at the access servers close to the users, [ADV1, ADV10]. An AS that is missing a fragment may request at its edge server where to find the missing fragment. Snooping is also a means by which access servers may be informed of a missing fragment at another AS by peeking into that access server's request for the missing fragment. If a snooping AS detects that it has the missing fragment in its sliding window, then it can directly copy the missing fragment and transmit it over the third links 23 to the AS that needs it. In this manner the load on the second links 11 reduces considerably, and the load on the first links 9 will also reduce. Should the demand for popular material increase, for example to the extent that the first links 9 are overloaded, then the duplication means 72 in an AS may make copies of highly demanded fragments and transmit them to other access servers. In doing so the length of the transmission paths will reduce in the network containing the first links, thereby setting more bandwidth free.

Private Video Recording (PVR) does not require the fragments of a movie be stored in sequential order at the recorder. They can be stored in any order and yet be played out in sequential order thanks to the protocol used for recording and rendering. With the invention it will also be possible to provide for simultaneous watching of a program (IPTV channel or video channel or both) and PVR of another program. Exemplary the file sharing client at an AS transmits two requests to the edge server, one for the program to be watched, that is the program to be streamed to the user, and another for the program to be recorded, the latter request giving as result the addresses of the servers at which the fragments are available and can be fetched by the client. Each time a fragment is received by the client it is multiplexed on the DSL to the user and transmitted to PVR recorder irrespective of the sequence order, [ADV11].

The file sharing client/server protocol 26 implements the file sharing protocol and uplinks to the corresponding ES.

Based on subscriber specific management info, information streams are generated internally by the AS and placed into the storage to stream to the users. This can be used to inform the subscriber about quotas, rates, service binding and line status.

As appears in FIG. 4 and FIG. 9 an AS is provided with a small icon that illustrates users, an ES has a small icon that illustrates a folder containing information and the CS has a small con that illustrates a data base containing a big amount of information. The user icon in the AS symbolizes that the AS serves as a proxy for the users, the folder icon that the ES contains moderate amounts of data material available to the ASs, and the data base icon in the CS that the CS holds large amounts of data material available to the ESs.

Although the invention has been described in connection with a wireline system with digital subscriber lines, IPDSLAMS, switches etc. it is not restricted to this. The invention may equally well be implemented in a wireless system, in which case the customer premises equipment is replaced by a mobile phone, a digital subscriber line is replaced by a radio channel, an IPDSLAM is replaced by a base station BS, an Ethernet switch by an SGSN (serving GPRS support node) and the BRAS as a GGSN (Gateway GPRS support node), [ADV13].

An edge server need not sit on the edge between a transport network 3 and an aggregation network as shown, it may be directly connected to the transport network from within the ES can reach the aggregation network.

### REFERENCES

[Ref. 1] “Optimizing the Broadband Aggregation Network for Triple Play Services” available at (comment: add the references in an own chapter at the end of the document) http://www.alcatel.se/gsearch/search.jhtml:jsessionid=JZGU31I1QEKBKCTFR 0HHJHAKMWHI0TNS?_requestid=387550, May 23, 2006
[Ref. 2] ITU-T G992.5, Asymmetric Digital Subscriber Line (ADSL) transceiver—Extended bandwidth ADSL2 (ADSL2plus), 05/2003+Amendment 1 07/2005
[Ref. 3] Ericsson DSL Access 2.2 (EDA 2.2 System Overview, 1/1551-HSC 901 35/3 Uen C 2005 Dec. 2, 12/2005, Ericsson
[Ref. 4] ITU-T G993.2, Very high speed digital subscriber line 2, 04/2006
[Ref. 5] http://en.wikipedia.org/wiki/Bittorrent (Apr. 19, 2006) or at http://bittorrent.com (same date) (move references).
[Ref. 6] Real Time Streaming Protocol, RFC 2326, 4/1998, H Schulzrinne, R. Lanphier

1-20. (canceled)

21. A distributed server framework for providing triple and play services to end users, using a streaming technique, said framework comprising:
a central server having a central data store for storing large amounts of data material;
a plurality of regional edge servers connected to the central server, the edge servers having a regional data store for temporary storing of fragments of the data material; and
a plurality of local groups of access servers connected to the regional servers, the access servers having an access data store for temporary storage of fragments of the data material;
wherein the access servers of a given group are connected to a given edge server over respective first links, the edge servers are connected to the central server over respective second links, and the access servers within each group are inter-connected over third links;
wherein each access server is connected to a multiplexer/demultiplexer to which equipment of a limited number of end users are connected;
the central server, edge servers and access servers each having client/server file sharing software for communication over the first, second, and third links using an IP-based file sharing protocol, wherein when the software is run on a processor of each server, the servers are caused to:
(a) diffuse file fragments of data material requested by end users from the central server to the edge servers and to the access servers, and
(b) store diffused file fragments at respective edge servers and access servers for a respective predefined time in accordance with the frequencies by which the stored data material is requested by end users.

22. The distributed server framework as recited in claim 21, wherein:
the central server includes means for maintaining a track list of the identities of the file fragments the central server has diffused to the edge servers and access servers; and
each edge server includes means for maintaining a respective track list of the identities of the fragments diffused to the access servers and hit lists of the number of times an identified fragment has been requested.

23. The distributed server framework as recited in claim 22, wherein:
the access servers temporarily store highly popular file fragments frequently requested by end users, and each access server includes:
(a) means for allotting a first expiration time;
(b) means for deleting a highly popular file fragment when the first expiration time expires and no requests for the highly popular file fragment has been received; and
(c) means for extending the first expiration time for the highly popular file fragment each time the highly popular file fragment is requested;
the regional servers temporarily store less popular file fragments that are less frequently requested by the end users, and each regional server includes:
(a) means for allotting a second expiration time, longer than the first expiration time,
(b) means for deleting a less popular file fragment when the second expiration time expires and no requests for the less popular file fragment has been received; and
(c) means for extending the second expiration time for the less popular file fragment each time the less popular file fragment is requested; and
the central server stores least popular data material seldom requested by the users.

24. The distributed server framework as recited in claim 23, wherein each access server includes a file sharing protocol client for storing in the access store file fragments according to a sliding window and cursor mechanism.

25. The distributed server framework as recited in claim 24, wherein the sliding window and cursor mechanism comprises a window moving in real time and a cursor pointing at a fragment that has the highest fetching priority for being fetched and streamed to the end user by the access server.

26. The distributed server framework as recited in claim 25, wherein each access server also includes:
means for receiving a request for identified data material from an individual end user;
means for retrieving the requested data material from edge servers and other access servers that contain the requested data material; and
means for streaming the requested data material to the end user that made the request.

27. The distributed server framework as recited in claim 26, wherein each access server includes means for retrieving over the third links, file fragments on other access servers provided the other access servers have the requested file fragments within the other access servers' respective sliding windows.

28. The distributed server framework as recited in claim 27, wherein a first access server includes:
means for snooping requests from other access servers to see if a fragment that the first access server is lacking is within the sliding window on any of the other access servers; and
means responsive to locating the lacking fragment, for fetching the lacking fragment from the access server where the lacking fragment is located.

29. The distributed server framework as recited in claim 28, wherein at least one access server is connected to more than one multiplexer/demultiplexer.

30. The distributed server framework as recited in claim 29, wherein the multiplexer/demultiplexer is connected to a data Virtual Local Area Network (VLAN), a video VLAN, and a voice VLAN for providing data, video and voice services to the end users.

31. The distributed server framework as recited in claim 30, wherein the user equipments access the access servers through a mobile radio network.

32. The distributed server framework as recited in claim 24, wherein the user equipments access the access servers through an Ethernet-based network, and the multiplexer/demultiplexer is an IP-based digital subscriber line access multiplexer (IP-DSLAM).

33. The distributed server framework as recited in claim 24, wherein the file sharing software is a bittorrent protocol modified so that the protocol does not include end user machines in the file sharing protocol and modified so that the protocol includes the sliding window and cursor mechanism.

34. An access server for distributing an individualized stream of data material to user equipments adapted to be connected to the access server through a multiplexer/demultiplexer, the access server comprising:
a file sharing client/server protocol;
stream generation means; and
data storage means;
wherein the file sharing client/server protocol includes:
means for maintaining a hit list for counting the number of times an identified fragment of a data material is requested by the file sharing client/server protocol; and
time out means for deleting an identified fragment if there are no hits on the identified fragment during a predefined time.

35. The access server as recited in claim 34, wherein the file sharing client/server protocol also includes a sliding window and cursor mechanism for fetching and streaming to the user equipments, fragments of a requested data material in sequential order.

36. The access server as recited in claim 34, wherein the access server stores data material that is popular and frequently requested by users, and the first predefined time is less than five days.

37. The access server as recited in claim 34, further comprising duplication means for duplicating fragments at the access server.

38. An edge server located at an edge between an IP-based transport network and an access network, the edge server for distributing data material to access servers in the access network, said edge server comprising:
a file sharing client/server protocol;
stream generation means; and
data storage means;
wherein the file sharing client/server protocol includes:
a tracker comprising a list having as entries, identified fragments of data material and associated with each entry an address to an access server on which the identified fragment is stored;
a hit list for counting the number of times an identified fragment of a data material is requested by the file sharing client/server protocol; and
time out means for deleting an identified fragment if there are no hits on the identified fragment during a predefined time.

39. The edge server as recited in claim 38, wherein the edge server stores data material that is less popular and less frequently requested by users than the data material stored on access servers, and the predefined time is approximately 5 days.
